(19) United States
(12) Patent Application Publication
(10) Pub. No.: US 2014/0058016 A1
(43) Pub. Date: Feb. 27, 2014

(54) Powder Coating Composition for Structuring and Texturing Coating Surfaces

(71) Applicants: Timo Herrlich, Buehl (DE); Tobias Niederleitner, Feigenhofen (DE)

(72) Inventors: Timo Herrlich, Buehl (DE); Tobias Niederleitner, Feigenhofen (DE)

(73) Assignee: CLARIANT FINANCE (BVI) LIMITED, Tortola (VG)

(21) Appl. No.: 14/005,518

(22) PCT Filed: Mar. 9, 2012
(86) PCT No.: PCT/EP2012/001051

§ 371 Date: Nov. 11, 2013

(30) Foreign Application Priority Data
Mar. 17, 2011 (DE) 10 2011 014 250.9

(51) Int. Cl. C09D 5/03

(52) U.S. Cl. CPC C09D 5/037
USPC 523/451; 523/457; 523/466; 523/455

(57) ABSTRACT

The invention relates to the use of a powder coating composition consisting of a bonding agent system, a wax comprising an acid group, one or more basic metal compounds or SiO₂ for producing a textured/structured coating surface.

The present invention relates to a powder coating composition which leads to structured and/or textured coating-film surfaces and at the same time to a reduced flow during the curing operation.

### PRIOR ART

Powder coating materials are becoming increasingly important for coating applications on account of their easy handling qualities and their low solvent requirement and associated low level of emission during coating. By means of appropriate additives it is possible to produce powder-based coating systems in both glossy and matt embodiments. One problem which frequently occurs, especially in the case of glossy coating surfaces, is the development of fingerprints in the course of everyday service. In general this problem is solved by the generation of a matted surface and/or of a macroscopically visible surface roughness. This is achieved through the use of inert and/or (co-)reactive adjuvants. In connection with macroscopic surface roughness and its morphological properties, one also talks of structuring or texturing. The structuring is apparent in the form of a more or less strongly pronounced graining of the surface.

Generally speaking, powder coating materials can be subdivided, according to their matrix or their binder system, into thermoplastic powder coatings (polyethylene, polyvinyl chloride, polyamides, ethylene-vinyl alcohol copolymers, thermoplastic polyesters) and crosslinking powder coatings (epoxy resin, epoxy resin/polyester hybrid systems, reactive polyesters). In comparison to crosslinking powder coatings, thermoplastic powder coatings are more favorably priced but also less resistant and are therefore used mostly for interior coatings. Depending on the binder system, a suitable choice of a matting agent or of a structuring agent may be used to adjust the surface morphology. The mode of action of matting agents and structuring agents is very similar. The critical factor is the formation of a microscopic surface roughness in the case of a matting agent, or of a macroscopic roughness of the surface in the case of a structuring agent. Matting effects may be determined by means of gloss measurement in accordance with ISO 2813. The characteristic parameters of a macroscopically visible surface roughness, in contrast, can be determined in accordance with ISO 4288. In actual practice, however, this texturing is usually assessed on a purely qualitative basis, by means of reference specimens.

Matting agents and structuring agents may be present in the powder coating either as inert adjuvants or as reactive adjuvants. Examples of known inert matting agents include lime, feldspar, fumed silica, kieselguhr, or polyolefin waxes. Matting agents whose effect is based on a chemical reaction in the course of curing usually lead to phase-separated domains incompatible with the coating matrix. Examples of such are bicyclic amidines for epoxide-based powder coatings, or reaction partners with different reactivity in the crosslinking operation. A disadvantage for the resistance of the matted powder coatings thus produced is the associated phase separation and hence the coherence of such a coating system.

The use of semicrystalline waxes as matting agents represents one particularly elegant method for obtaining matting effects, since as well as a matting effect these agents improve numerous other properties in the powder coating (EP-A-0 890 619). These properties include improving the scratch resistance, the abrasion resistance, the dispersing of pigments, the pigment stability, the lubricity characteristics, the metal marking qualities, the blocking resistance, and the tactile qualities. In addition, the use of waxes positively influences the rheological properties of the powder coating, allowing waxes in powder coatings to be used additionally for increasing throughput, when they are produced in an extruder, and as a degassing additive during the baking operation.

Structuring agents act in a similar way to matting agents. Known inert structuring additives include powder-form PTFE (polytetrafluoroethylenes) or PVDF (polyvinylidene fluoride) polymers, and also inorganic aluminum oxides. Jeno et al. in EP0806459 describe the use of organophilic clays or crosslinked rubber particles as inert texturing additives in epoxide-based powder coatings. Structuring by means of a reactive system in epoxide-based powder coatings were achieved by Schreffler et al. (U.S. Pat. No. 5,212,263) through the formulation of bisphenol A diglycidyl ether, disalicylic acid, and an imidazole derivative. Patel et al. (U.S. Pat. No. 5,554,681) achieved surface structuring through the use of precrosslinked silicone resin in conjunction with an acrylate resin and silica as flow improver.

A disadvantage associated with the aforementioned methods is the use of the raw materials, such as PVDF and PTFE, for example, which are expensive by comparison with other coating components. Furthermore, precrosslinked silicone resin, which is generally elastic, imposes particular demands on the grinding operation, in order to obtain the particle size required for the powder coating. Norris et al. (WO-0242385) describe the structuring through the use of at least 9 wt. % of a branched, low molecular mass polyester having terminal acid groups, in conjunction with, preferably, an epoxide-functional co-reagent. The high demand, on the one hand, for low molecular mass reactants, and the associated difficulties in the extrusion and grinding operation, and also the reaction partners that are classified generally as injurious to health, shows a high level of optimizability in the field of structuring additives for powder coatings.

The abovementioned powder coating additives for surface structuring do not in all respects meet the desired performance requirements, especially in relation to their costs in production and further processing, low volatility, and their sustainability, such as halogen-free raw material basis, for example.

It has now been found that acid-group-containing waxes in conjunction with basic polyvalent basic metal salts are capable of developing structuring in powder coatings. At the same time it has been found that the combination of acid-group-containing waxes and one or more basic metal compounds gives the powder coating a particularly good leveling stability during baking, owing to accelerated melt thickening (thixotropy).

The invention relates to the use of acid-group-containing waxes in conjunction with one or more basic metal compounds or SiO₂ for forming structured/textured coating surfaces in powder coatings.

As a binder system for the powder coating systems of the invention it is possible to use both thermoplastic and thermosetting polymers.

The acid content of the waxes used is preferably between 5 and 135 mg KOH/g. With more particular preference, the acid-group-containing waxes, based on the total weight of the powder coatings, are used in amounts of 1 to 6 wt. %.

In another preferred embodiment, the basic metal compounds, based on the total weight of the powder coatings, are used in amounts of 5 to 50 wt. %.

The acid-group-containing waxes are more particularly oxidized polyolefins, preferably polyolefins (homopolymers or copolymers) grafted with maleic anhydride, or copolymers of 1-olefins and maleic anhydride.

The 1-olefins preferably consist of chain lengths having ≧30 C atoms.

In another preferred embodiment the acid-group-containing waxes are copolymers of ethylene and acrylic acid, preferably being polyolefins grafted with acrylic acid.

The basic metal compounds used are preferably metal oxides, carbonates, hydroxides, acetates, phosphates, or acetylacetonates, more particularly metals and semimetals from main groups 2, 3, 4, and 5, and also transition metals from transition groups 4 and 12.

Particularly preferred here are SiO₂, TiO₂, CaCO₃ and/or ZnO.

In accordance with the invention the additive combination of acid-group-containing waxes with basic metal compounds improves the structuring or texturing on the coating surface of powder coatings, and also, at the same time, improves the rheological properties during baking, especially the thixotroping.

The present invention is applicable to all customary types of powder coatings, of the kind described, for example, in Ullmanns Encyclopädie der technischen Chemie, 5th edition, vol. A18, pages 438-444, Verlag Chemie Weinheim 1991.

### EXAMPLES

In the production of the powder coating, all of the constituents are first premixed in a mixer and then homogenized in an extrusion operation at temperatures between 80 and 130° C. At the end, the homogenous composition is adjusted to the desired particle size by grinding and screening. In this operation, an extremely fine division of the pigments and fillers is required. Present-day state of the art for the dispersing of all of the components are single-screw and twin-screw extruders, and also kneading apparatus without dispersing assistants.

The screened particles are applied using a spray gun with corona charging. The particles, applied to a metal plate, are heated at 180° C. in an oven for 15 minutes. During this time, the particles melt and form a uniform coating. After this so-called baking operation, the coated plates are stored in a controlled-climate room for 24 hours, after which the gloss (60°) is measured. The structuring is both qualitatively assessed and determined from the gloss figures. By virtue of the structuring properties of the mixture, the gloss figures lie in a region below 60°.

TABLE 1
Characteristic data of the tested waxes.

| | Acid | | |
|---|---|---|---|
| Product | number | Viscosity | Dropping point |
| maleinized PE wax | about 45 | about 350 (140° C.) | about 123 |
| PE wax | 0 | about 60 (140° C.) | about 127 |
| PP wax | 0 | about 60 (170° C.) | about 145 |
| maleinized PP wax | about 41 | about 1100 (170° C.) | about 140 |
| copolymer wax | about 80 | about 350 (100° C.) | about 73 |

The stated wax components are added in a hybrid powder coating in the following mixing proportion:

TABLE 2
Powder coating composition for the hybrid powder coating.

| Constituents | No wax | 2.0 wt. % fraction | 4.0 wt. % fraction |
|---|---|---|---|
| Crylcoat 1770-0 | 424.7 | 416.2 | 407.7 |
| D.E.R. 663U-E | 182.0 | 178.4 | 174.7 |
| Additol P 896 | 40.0 | 39.2 | 38.4 |
| Benzoin | 3.3 | 3.2 | 3.2 |
| Blancfixe F | 87.5 | 85.8 | 84.0 |
| Kronos 2160 (TiO₂) | 245.0 | 240.0 | 235.2 |
| PV Fast Blue A2R | 17.5 | 17.2 | 16.8 |
| Wax | 0 | 20.0 | 40.0 |

The examples from table 3 were produced in accordance with the formulations from table 2 with the corresponding waxes.

TABLE 3
Variation in the waxes used.

| Products | Examples |
|---|---|
| no wax | 1 |
| maleinized PE wax | |
| 2% | 2 |
| 4% | 3 |
| PE wax | |
| 2% | 4 |
| 4% | 5 |
| PP wax | |
| 2% | 6 |
| 4% | 7 |
| maleinized PP wax | |
| 2% | 8 |
| 4% | 9 |
| copolymer wax | |
| 2% | 10 |
| 4% | 11 |

The coated metal plates were stored in a controlled-climate room for 24 hours, after which the gloss figure was ascertained. The results show that the degree of gloss undergoes superproportional reduction only at elevated concentration. This effect is in agreement with the macroscopic structuring that is visible.

TABLE 4
Gloss measurement and qualitative assessment

| Examples | Gloss 60° | Appearance (tactility) |
|---|---|---|
| comparative example 1 | 97 | glossy (smooth) |
| inventive example 2 | 79 | matt (grainy) |
| inventive example 3 | 42 | matt (grainy) |
| comparative example 4 | 89 | slightly matted (smooth) |
| comparative example 5 | 79 | slightly matted (smooth) |
| comparative example 6 | 78 | slightly matted (smooth) |
| comparative example 7 | 74 | slightly matted (smooth) |
| inventive example 8 | 70 | matt (grainy) |
| inventive example 9 | 43 | matt (grainy) |
| inventive example 10 | 75 | matt (grainy) |
| inventive example 11 | 44 | matt (grainy) |

The stated wax components were likewise investigated on the basis of a hybrid powder coating of an increased fraction of titanium dioxide:

TABLE 5
Powder coating composition for the hybrid powder coatings with
increased titanium dioxide fraction

| Constituents | No wax | 2.0 wt. % fraction | 4.0 wt. % fraction |
|---|---|---|---|
| Crylcoat 1770-0 | 365.6 | 358.3 | 351.0 |
| D.E.R. 663U-E | 156.7 | 153.6 | 150.4 |
| Additol P 896 | 34.4 | 33.7 | 33.1 |
| Benzoin | 2.8 | 2.8 | 2.7 |
| Blancfixe F | 75.3 | 73.8 | 72.3 |
| Kronos 2160 (TiO₂) | 350.0 | 343.0 | 336.0 |
| PV Fast Blue A2R | 15.1 | 14.8 | 14.5 |
| Wax | | 20.0 | 40.0 |

The following mixing proportions are the bases for examples 12-22.

TABLE 6
Variation in the waxes used

| Products | Examples |
|---|---|
| no wax | 12 |
| modified PE wax | |
| 2% | 13 |
| 4% | 14 |
| PE wax | |
| 2% | 15 |
| 4% | 16 |
| PP wax | |
| 2% | 17 |
| 4% | 18 |
| modified PP wax | |
| 2% | 19 |
| 4% | 20 |
| copolymer wax | |
| 2% | 21 |
| 4% | 22 |

TABLE 7
Gloss measurement and qualitative assessment

| | Gloss | |
|---|---|---|
| Examples | 60° | Appearance (tactility) |
| comparative example 12 | 90 | glossy (smooth) |
| inventive example 13 | 12 | matt (highly grainy) |
| inventive example 14 | 2 | matt (highly grainy) |
| comparative example 15 | 88 | glossy (smooth) |
| comparative example 16 | 83 | slightly matted (smooth) |
| comparative example 17 | 85 | slightly matted (smooth) |
| comparative example 18 | 80 | slightly matted (smooth) |
| inventive example 19 | 53 | matt (grainy) |
| inventive example 20 | 15 | matt (highly grainy) |
| inventive example 21 | 15 | matt (highly grainy) |
| inventive example 22 | 7 | matt (highly grainy) |

In accordance with the invention it has been shown that the powder coatings with acid-group-containing waxes (especially with maleic anhydride-grafted waxes) in conjunction with TiO₂ exhibit particularly strong structuring. Furthermore it has been shown in accordance with the invention that the leveling properties were improved during the baking operation.

The combination of acid-group-containing waxes, TiO₂, and Al(acac) or CaCO3 and likewise showed strong structuring. The following formulations according to the invention were tested with different wax concentrations.

TABLE 8
Powder coating composition for the hybrid powder coatings
acid wax and aluminum acetylacetonate

| | | 4.0 wt. % | 6.0 wt. % | 8.0 wt. % |
|---|---|---|---|---|
| Constituents | No wax | fraction | fraction | fraction |
| Crylcoat 1770-0 | 424.7 | 407.7 | 399.2 | 390.7 |
| D.E.R. 663U-E | 182.0 | 174.7 | 171.1 | 167.4 |
| Additol P 896 | 40.0 | 38.4 | 37.6 | 36.8 |
| Benzoin | 3.3 | 3.2 | 3.1 | 3.0 |
| Blancfixe F | 87.5 | 84.0 | 82.3 | 80.5 |
| Kronos 2160 | 245.0 | 235.2 | 230.3 | 225.4 |
| PV Fast Blue A2R | 17.5 | 16.8 | 16.5 | 16.1 |
| Wax | | 20.0 | 20.0/40.0 | 40.0 |
| Aluminum acetylacetonate | | 20.0 | 20.0/40.0 | 40.0 |

TABLE 9
Variation in the waxes used

| Products | Examples |
|---|---|
| no wax | 23 |
| modified PE wax 2% | 24 |
| aluminum acetylacetonate 2% | |
| modified PE wax 4% | 25 |
| aluminum acetylacetonate 2% | |
| modified PE wax 2% | 26 |
| aluminum acetylacetonate 4% | |
| modified PE wax 4% | 27 |
| aluminum acetylacetonate 4% | |

TABLE 10
Gloss measurement and qualitative assessment

| Examples | Gloss 60° | Appearance (tactility) |
|---|---|---|
| comparative example 23 | 96 | glossy (smooth) |
| inventive example 24 | 13 | matt (highly grainy) |
| inventive example 25 | 9 | matt (highly grainy) |
| inventive example 26 | 1 | matt (highly grainy) |
| inventive example 27 | 1 | matt (highly grainy) |

TABLE 11
Powder coating composition for the hybrid powder coatings
acid wax and calcium carbonate

| Constituents | No wax | 2.0 wt. % fraction | 4.0 wt. % fraction |
|---|---|---|---|
| Crylcoat 1770-0 | 368.0 | 359.0 | 350.0 |
| D.E.R. 663U-E | 158.0 | 154.0 | 150.0 |
| Additol P 896 | 35.0 | 34.0 | 33.0 |
| Benzoin | 3.0 | 3.0 | 3.0 |
| Blancfixe F | 76.0 | 74.0 | 72.0 |
| Durcal 5 (CaCO₃) | 345.0 | 344.0 | 344.0 |
| PV Fast Blue A2R | 15.0 | 15.0 | 14.0 |
| Wax | | 17.0 | 34.0 |

TABLE 12
Variation in the waxes used

| Products | Examples |
|---|---|
| no wax | 28 |
| modified PE wax | |
| 2% | 29 |
| 4% | 30 |

TABLE 13
Gloss measurement and qualitative assessment.

| Examples | Gloss 60° | Appearance (tactility) |
|---|---|---|
| comparative example 28 | 72 | Glossy (smooth) |
| inventive example 29 | 44 | Matt (highly grainy) |
| inventive example 30 | 27 | Matt (highly grainy) |

TABLE 14
Thixotroping during the baking operation

| | Coat thickness | Coat thickness | Leveling |
|---|---|---|---|
| Example | middle [mm] | bottom edge [mm] | [%] |
| comparative example 1 | 0.13 | 0.22 | 69 |
| inventive example 3 | 0.12 | 0.16 | 33 |
| comparative example 5 | 0.12 | 0.20 | 67 |
| comparative example 7 | 0.11 | 0.18 | 63 |
| inventive example 9 | 0.10 | 0.12 | 20 |

In accordance with the invention it has been shown that the powder coatings with acid-group-containing waxes (especially with maleic anhydride-grafted waxes) in conjunction with TiO₂ and Al(acac) or CaCO3 exhibit particularly strong structuring.

It was additionally shown in accordance with the invention that the leveling properties were improved during the baking operation.

1. A powder coating composition for generating a textured/structured coating surface comprising a binder system, an acid-group-containing wax and one or more basic metal compounds, or SiO₂.

2. The composition as claimed in claim 1, wherein the binder system is a thermoplastic polymer or a thermosetting polymer.

3. The composition as claimed in claim 1, wherein the acid number of the wax is in the 5-135 mg KOH/g.

4. The composition as claimed in claim 1, wherein the wax is present from 1 to 6 wt %.

5. The composition as claimed in claim 1, wherein the basic metal compound or SiO₂ is present from 5 to 50 wt %.

6. The composition as claimed in claim 1, wherein the wax is formed by oxidation of a polyolefin.

7. The composition as claimed in claim 1, wherein the wax is formed by maleinization of a polyolefin homopolymer or copolymer.

8. The composition as claimed in claim 1, wherein the wax is formed by copolymerization of maleic anhydride and 1-olefins.

9. The composition as claimed in claim 8, wherein the 1-olefin consists of a chain length ≧30 C atoms.

10. The composition as claimed in claim 1, wherein the wax is formed by copolymerization of acrylic acid and ethylene.

11. The composition as claimed in claim 1, wherein the wax is formed by grafting of a polyolefin with acrylic acid.

12. The composition as claimed in claim 1, wherein the basic metal salt is a metal oxide, carbonate, hydroxide, acetate, phosphate, or acetylacetonate.

13. The composition as claimed in claim 10, wherein the basic metal compound is a metal from main group 2, 3, 4, or 5, or a transition metal from transition groups 4 and 12.

14. The composition as claimed in claim 10, wherein the basic metal compound is SiO₂, TiO₂, CaCO₃, ZnO, Al(acac)₃, or Zn(acac)₂.

15. A powder coating composition for thixotroping during the baking operation comprising a binder system, an acid-group-containing wax and one or more basic metal compounds, or SiO₂.

16. The composition as claimed in claim 1, further comprising crosslinking agents, crosslinking accelerators, pigments, UV stabilizers.

17. The composition as claimed in claim 2, wherein the thermoplastic polymer is selected from the group consisting of polyethylene, polyvinyl chloride, polyvinylidene fluoride, polyamides, ethylene-vinyl alcohol copolymers and thermoplastic polyesters.

18. The composition as claimed in claim 2, wherein the thermosetting polymer is selected from the group consisting of epoxy resin, epoxy resin/polyester hybrid systems and reactive polyesters.
